(19) United States
(12) Patent Application Publication
(10) Pub. No.: US 2018/0109661 A1
(43) Pub. Date: Apr. 19, 2018

(54) MOBILE DEVICE STAND

(71) Applicant: Steven Palen, Shelby Township, MI (US)

(72) Inventor: Steven Palen, Shelby Township, MI (US)

(21) Appl. No.: 15/729,781

(22) Filed: Oct. 11, 2017

Related U.S. Application Data
(60) Provisional application No. 62/408,104, filed on Oct. 14, 2016.

(51) Int. Cl. H04M 1/04; F16M 11/08; F16M 11/10

(52) U.S. Cl. CPC H04M 1/04; F16M 11/10; F16M 11/08

(57) ABSTRACT

The present invention provides a mobile device stand which allows a mobile device to be rotatably and tiltably positioned while not obstructing the audio output from the mobile device. The stand hereof includes a base and a support member. The base includes a stationary member and a rotatable member rotatably mounted atop the stationary member. The support member includes a frame disposed above the rotatable member and a support plate disposed on the frame.

### CROSS-REFERENCE TO RELATED APPLICATION

This application is a completion application which claims the priority benefit of co-pending U.S. Provisional Patent Application Ser. No. 62/408,104, filed Oct. 14, 2016, for “Mobile Device Stand,” the entire disclosure of which, including the drawing, is hereby incorporated by reference.

### BACKGROUND OF THE INVENTION

### 1. Field of the Invention

The present invention pertains to stands and supports. More particularly, the present invention concerns stands for mobile devices. Even more particularly, the present invention pertains to rotatable and tiltable stands for mobile devices.

### 2. Description of Related Art

With the advancements in mobile technology, more people are using hand-held mobile devices such as tablets, mobile phones, music players, or the like. Activities such as watching videos and listening to music on a mobile device does not require it to be hand-held and, most times, it is preferred that the mobile device be situated or oriented on its own in order to free the user's hands for additional purposes.

The prior art has addressed this situation by proposing a number of stands or mounts for supporting a mobile device that allows it to be held in an upright fashion while ensuring not to obstruct the display screen of the mobile device.

For example, U.S. Pat. No. 9,074,725 to Trotsky discloses a positioning unit for a mobile device including a frame which retains at least one edge of the mobile device in position. As the mobile device is secured within the frame, a grip member allows the frame and, thus, the mobile device to be propped up and rotated at a given angle such that the mobile device can be operated without being held by the user. One shortcoming in Trotsky is that, because of the low positioning of the mobile device relative to the frame, the speakers of the mobile device are typically angled downwardly and muffled by the surface upon which the positioning unit is propped up on. Therefore, it is not an ideal system for listening to music or watching a movie as the audio is obstructed. Additionally, the frame is limited to only supporting a single-sized mobile device.

U.S. Patent Publication Serial No. 2016/0173670 to Langhein is similar to the unit disclosed in Trotsky such that a frame encases at least one edge of a mobile device and is adapted to prop the mobile device up at a desired angle. The same shortcoming as in Trostsky is exhibited here where the audio becomes muffled as the speakers of the mobile device are typically in close proximity to a surface just below the frame. Moreover, the frame is not adjustable in height or width and, therefore, cannot accommodate mobile devices of different dimensions.

U.S. Patent Publication Serial No. 2012/0170194 to Lord et al. discloses a stand for a mobile device having a rotatable member and a base member connected to the rotatable member. The base member is disposed at a distance above the rotatable member in order to provide a space below the base member for audio signals to be transmitted without becoming muffled. However, Lord only accommodates a single sized mobile device remains an issue.

U.S. Pat. No. 8,528,690 to Wu teaches a sound effect amplification diffuser which holds a mobile device within a deck in a stationary position. In use, one side of the mobile device is situated within a bearing space and a sound collection hole provides means for redirecting audio signals through the deck. While Wu manages to provide a solution to the common problem of muffling of sound emanating from the mobile device, it fails to provide any repositioning of the mobile device while situated within the deck.

Lastly, U.S. Pat. No. 8,320,597 to Griffin and U.S. Pat. No. 9,100,751 to Kim et al. each provide a base for positioning a mobile device and redirecting sound out of a side of the base through at least one intricate cavity in order to amplify and enhance the quality of the audio. While the device in Griffin teaches a mobile device that remains stationary, Kim provides a stand having the ability to tilt a mobile device forward and backward relative to the base. Nonetheless, both references fail to teach a base that can both rotate and tilt a mobile device while disposed within the base. Further, the base described in both of the above references only accommodates a single size mobile device having speakers in specific locations along the base of the mobile device in order for the base to efficiently redirect the audio.

Additionally, while each of the devices disclosed in the above references are suitable for the uses and problems they intend to solve, there is an ongoing need for improvements in a mobile device stand, such as one that can accommodate any number of mobile devices having varying dimensions and allows a mobile device disposed therein to both tilt and.

It is to this to which the present invention is directed.

These above references are identified herein in recognition of a duty of disclosure of related subject matter, which may be relevant under 37 CFR 1.56, and specifically incorporated, herein by reference as regards the conventional approaches and constructions taught therein.

### SUMMARY OF THE INVENTION

The present invention provides a mobile device stand comprising: (a) a base, the base including: (i) a stationary member, the stationary member having a top surface and a bottom surface: and (ii) a rotatable member, the rotatable member having a top surface and a bottom surface, the rotatable member being rotatably mounted on the top surface of the stationary member; and (b) a support member, the support member including: (i) a frame having a front surface and a back surface; and (ii) a support plate being disposed on the frame, the frame being tiltably mounted on the rotatable member.

The support plate comprises at least one and, preferably, a plurality of tubular cavities extending vertically through the support plate in order to provide a passageway for audio signals or sound to be transmitted from the mobile device. A cavity is also formed within a central portion of the support plate to allow for a cable, such as a charging cable, data transfer cable, or the like, to be connected to a mobile device when positioned atop the support plate.

In use, a mobile device is placed atop the support plate and leans against the frame for support when the frame tilts and/or rotates.

The present invention also accommodates various sized mobile devices.

For a better understanding of the present invention, reference is made to the accompanying drawing and detailed description. In the drawing, like reference numerals refer to like parts through the several views, in which:

### BRIEF DESCRIPTION OF THE DRAWING

FIG. 1 is a front, perspective view of a mobile device stand in accordance with the present invention;

FIG. 2 is a rear perspective view thereof;

FIG. 3 is a side view thereof; and

FIG. 4 is a cross-sectional view taken along line 4-4 of FIG. 3.

### DETAILED DESCRIPTION OF THE INVENTION

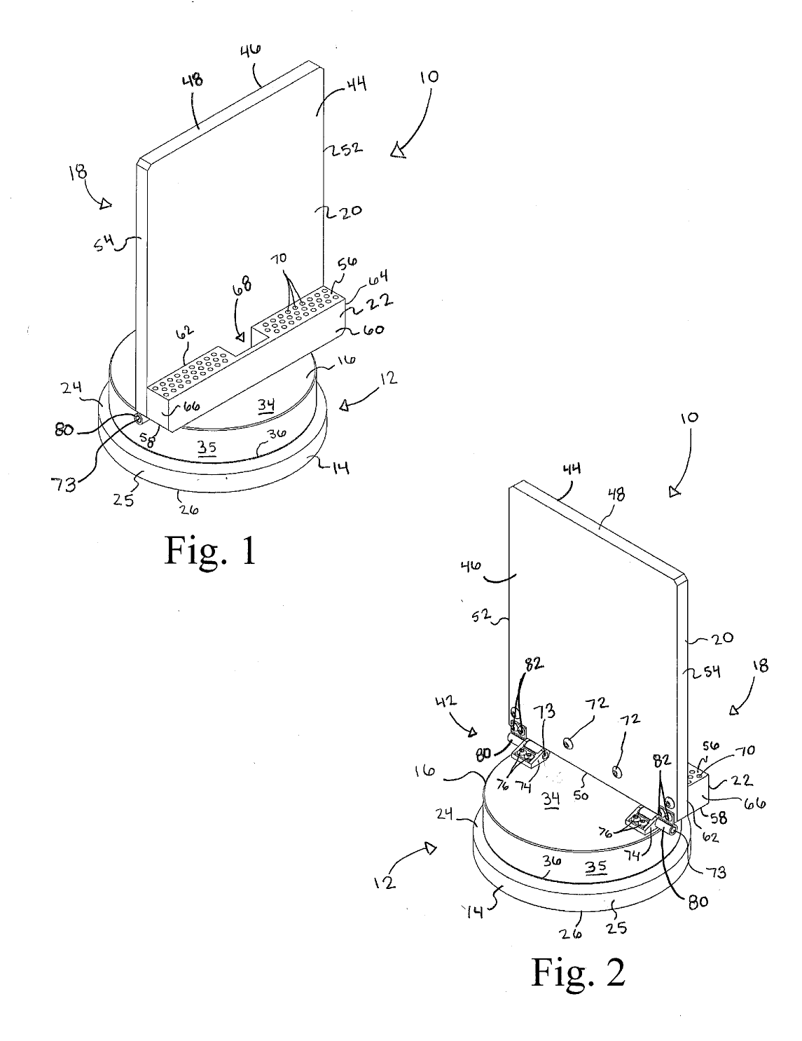

Now, and in accordance with the present invention and with reference to FIGS. 1-4 of the drawing, there is provided a mobile device stand, generally, denoted at 10 comprising: (a) a base 12 including a stationary member 14 and a rotatable member 16 rotatably mounted atop the stationary member 14; and (b) a support member 18 including a frame 20 disposed above the rotatable member 16 and a support plate 22 disposed on the frame 20.

As described below, the channel 28 provides a cavity for receiving and retaining means for rotating 30, such as a screw, rod, shaft, or the like. Preferably, the means for rotating 30 is a shoulder screw 32 or the like.

In order to properly accommodate the shoulder screw 32, the channel 28 has a diameter slightly larger than that of the shoulder screw 32 in order to enable free rotation of the shoulder screw 32 within the channel 28. Where a shoulder screw is used, a shoulder 29 may be provided within the channel 28 in order to maintain the vertical position of the shoulder screw 32 within the channel 28.

The stationary member 14 is generally formed from a solid material such as metal, wood, plastic, or the like, which provides a sturdy structure to support the weight of a mobile device (not shown) to be positioned thereon, as described below.

As shown, the stationary member 14 is a substantially cylindrical member having a top surface 24, a peripheral edge 25, and a bottom surface 26. The stationary member 14 further includes a channel 28 formed through both the top surface 24 and the bottom surface 26. Preferably, the channel 28 is formed at a substantially central portion of the stationary member 14.

It is to be understood that the stationary, while shown as rectangular, member 14 may be of any desired shape.

The rotatable member 16 is disposed above the stationary member 14. The rotatable member 16 is, also, a generally solid piece of material such as metal, wood, plastic, or the like. While it is essential that the stationary member 14 provide sufficient support to stabilize a mobile device above the rotatable member 16, preferably, the rotatable member 16 comprises the same material as the stationary member 14 for improved functionality and aesthetic purposes.

The rotatable member 16 may also be any shape, but, preferably, is the same shape as the stationary member 14. Therefore, the rotatable member 16 is illustrated as a substantially cylindrical member having a top surface 34, a peripheral edge 35, and a bottom surface 36 and, they resemble a turn table.

A bore 38 is formed in the rotatable member 16 and extends upwardly, from the bottom surface but short of the top surface 24. The bore 38 includes circumferentially disposed threads 40 that mate with threads on the shoulder screw 32. Therefore, the bore 38 has a reduced or smaller diameter than that of the channel 28 in order to mate with the shoulder screw 32 and prevent the shoulder screw 32 from being lifted through the top surface 24 of the stationary member 14.

In assembling the base 12, the rotatable member 16 is positioned above the stationary member 14 such that the channel 28 and bore 38 are in registry with one another. Thereafter, the shoulder screw 32 is inserted into the channel 28 through the bottom surface 26 of the stationary member 14 and is threadably secured in the bore 38 via the threads 40 in the rotatable member 16. As noted above, the diameter of the channel 28 is oversized in order to allow the rotatable member 16, which is secured to the shoulder screw 32, to turn on its axis without being restricted by the stationary member 14. The shoulder screw 32 is then maintained vertically by the shoulder 29, the smaller diameter of the bore 38 and the threaded securement.

As shown in FIGS. 1-3, the frame 20 which may be any shape and size, but is preferably large enough to support at least a portion of and, preferably, an entire mobile device, such as a phone, tablet, or the like is tiltably mounted above the rotatable member 16. The frame 20 is tiltably mounted to the rotatable member 16 by means for tilting 42. The frame 20 may comprise the same or different materials used in fabricating the stationary member 14 and/or rotatable member 16. While, the frame 20 is shown here as, generally, rectangular having a front surface 44 and a back surface 46. The frame 20 further includes a top edge 48, bottom edge 50, and a pair of opposed side edges 52, 54 interconnecting the front surface 44 and back surface 46. The material from which the frame 20 is fabricated is not crucial to the present invention.

As noted above, the frame 20 further includes a support plate or block 27. In order to provide optimal support, the support plate 22 is disposed proximate the lower edge 50 of the frame 20, either on the front surface 20 or the back surface 46. While there is no structural difference between the front surface 44 and the back surface 46 of the frame 20, the support plate 22 may be disposed on either surface 44, 46. Thus, for purposes of the ensuing description, all reference will be made to the support plate 22 being mounted to the front surface 44 of the frame 20.

The support plate 22 is an elongated, generally, solid plate formed from any suitable material such as described above. Preferably, the support plate 22 is fabricated from stainless steel. The support plate 22, as shown, is rectangular in shape having a top surface 56 and a bottom surface 58. The support plate 22 further includes a front surface 60, a back surface 62, and a pair of opposing sides 64, 66 interconnecting the top surface 56 and the bottom surface 58.

A cavity or passage 68 is formed medially of the support plate 22 in order to provide a passageway for a cable (not shown) to connect to an input in the bottom of the mobile device when situated atop the support plate 22. Since mobile devices regularly require to be charged after continued use via a charging cable or connected to a computer via a data transfer cable, the present device enables such charging. Additionally, mobile devices are commonly connected to a separate auxiliary device for audio reception purposes. Therefore, the cavity 68 is provided through the back surface 62 of the support plate 22 and extends between the top surface 56 and the bottom surface 58 of the support plate 22. The cavity 68 extends toward, but short of the front surface 60 of the support plate 22. The size of the cavity 68 can vary based on the type of cable being used. The cavity 68 is also strategically formed at a central location along back surface 62 of the support plate 22 since this is where most mobile devices include an input for such cables.

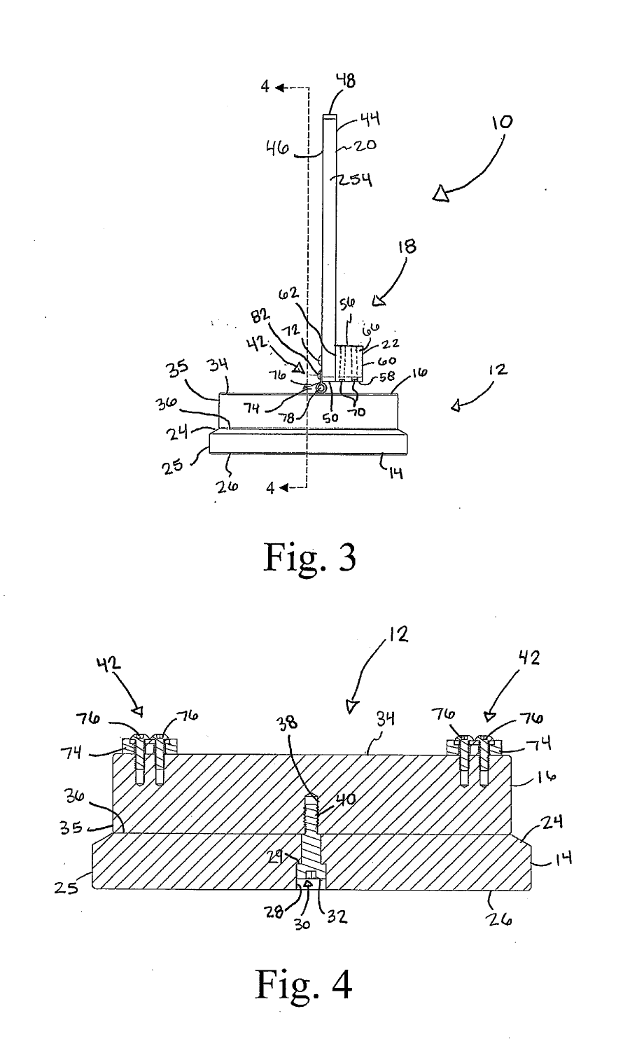

As shown in FIGS. 2 and 3, the support plate 22 further has at least one tubular cavity 70 vertically formed through the support plate 22. Preferably, a plurality of tubular, equidistantly spaced apart openings 70 are provided. The tubular openings 70 are formed within the support plate 22 by any suitable means such as fluid jet cutting, power drilling, or the like.

The tubular openings 70 provide a passageway for audio signals emanating from a speaker of the mobile device to pass through the support plate 22 unobstructed. As noted above, the support plate 22 may be fabricated from stainless steel. Stainless steel provides improved resonance and acoustic abilities when the audio signals passes through the support plate 22 in order to enhance the audio quality and ensure the support plate 22 does not absorb any of the signals as might be exhibited with other materials.

The support plate 22 is horizontally mounted to the front surface 44 of the frame 20 by any suitable means including threaded fasteners, such as screws, bolts, or rivets, an adhesive, or the like.

As shown in FIGS. 2 and 3, the support plate 22 is secured to the front surface 44 of the frame 20 using a plurality of threaded fasteners 72 which are evenly distributed proximate the bottom edge 50 of the frame 20 and into the back surface 62 of the support plate 22.

Without restriction, the support plate 22 may be mounted to the frame 20 at any desired location.

As noted above, the means for tilting 42 facilitates the tilting of the frame 20 about the rotatable member 16. Preferably, the means for tilting 42 comprises a friction hinge 73. Friction hinges are well known and commercially available such as those sold commercially by Hanaya, Inc. Friction hinges, commonly used in laptop monitors, are designed to provide adjustable tilt and rotation to devices at an infinite number of angles and are able to maintain their position after continual readjustment.

The friction hinge selected here should provide sufficient support for mobile devices weighing about 4 to about 6 pounds and have a minimum of about 30,000 rotations before starting to degrade in quality. It is to be understood that the capacity of the friction hinge chosen in constructing the present invention is chosen based on the specific mobile device intended to be supported. Various configurations of friction hinges in addition to those described below may be suitable for the intended purposes without deviating from the scope of the present invention.

As shown in FIGS. 2-4, the friction hinge 73, generally, comprises a first bracket 74 which is secured to the top surface 34 of the rotatable member 16 by at least one threaded fastener 76 (a pair of which are shown) proximate the peripheral edge 25 of the rotatable member 16. The friction hinge 73 further comprises a second bracket 80 rotatably secured to the first bracket 74. The second bracket 80 extends upwardly and is mounted to the back surface 46 of the frame 20 proximate the bottom edge 50 by at least one threaded fastener 82 (a pair of which are shown).

It is to be understood that only one configuration of a friction hinge is illustrated here, yet other configurations may be used without deviating from the present invention.

While only a single friction hinge 73 may be used, preferably, a pair of spaced apart friction hinges 73, are disposed along the bottom edge 50 of the frame 20 for optimal support.

Furthermore, while the friction hinges 73 and frame 20 are shown in FIGS. 1, 2 and 3 to be secured to the top surface 34 of the rotatable member 16 proximate a substantially central axis, the friction hinges 73 and frame 20 may be secured at any suitable location on the rotatable member 16.

From the above, it is to be appreciated that defined herein is a mobile device stand which allows a mobile device to be rotatably and tiltably positioned while not being limited to a single sized mobile device nor affecting the audio output from the mobile device.

Referring now to FIG. 5, there is depicted therein an alternate embodiment of the present stand, generally, depicted at 100. According to this embodiment, the frame 120 is substantially elliptical or ovular in configuration.

In all other respects, the present stand of this embodiment is the same as that of the first embodiment.

Having thus described the invention, what is claimed is:

1. A mobile device stand comprising:
(a) a base, the base including:
(i) a stationary member, the stationary member having a top surface and a bottom surface: and
(ii) a rotatable member, the rotatable member having a top surface and a bottom surface, the rotatable member being rotatably mounted on the top surface of the stationary member; and
(iii) means for enabling rotation of the rotatable member extending through the stationary member and partially into the rotatable member;
(b) a support member, the support member including:
(i) a frame having a front surface and a back surface; and
(ii) a support plate being disposed on the frame, the frame being tiltably mounted on the rotatable member.

2. The mobile device stand of claim 1 wherein the base further comprises:
(a) a channel formed through a substantially central portion of the stationary member and extending vertically;
(b) a threaded bore formed in the rotatable member and extending from the bottom surface and partially into the rotatable member, the threaded bore having a smaller diameter than the channel;
the means for enabling rotation comprises:
(c) a threaded fastener extending through the channel and into the threaded bore, the threaded fastener being secured within the threaded bore and freely rotatable about a vertical axis within the channel, thereby allowing the rotatable member to rotate atop the stationary member.

3. The mobile device stand of claim 2 wherein the threaded fastener is a shoulder screw.

4. The mobile device stand of claim 1 wherein the frame comprises:
means for tilting the frame with respect to the rotatable member.

5. The mobile device stand of claim 4 wherein the means for tilting comprises:
at least one friction hinge.

6. The mobile device stand of claim 4 wherein the means for tilting comprises:
a pair of spaced apart friction hinges, each one of the pair of friction hinges including a first bracket and a second bracket, the first bracket being fixed to the top surface of the rotatable member and the second bracket being fixed to the back surface of the frame, the first and second brackets being rotatably secured to each other.

7. The mobile device stand of claim 1 wherein the support plate is disposed on the front surface of the frame proximate a lower edge of thereof.

8. The mobile device stand of claim 1 wherein the support plate further comprises:
a passage formed therein and extending vertically therethrough, the passage enabling a cable to extend through the support plate.

9. The mobile device stand of claim 1 wherein the support plate further comprises:
at least one tubular opening extending vertically through the support plate to allow for audio signals emanating from a mobile device situated atop the support plate to pass through the support plate.

10. The mobile device stand of claim 1 wherein the support plate further comprises:
a plurality of tubular opening extending vertically through the support plate to allow for audio signals emanating from a mobile device situated atop the support plate to pass through the support plate.

11. The mobile device stand of claim 10 wherein the plurality of tubular opening are equidistantly spaced apart.
